(19) United States
(12) Patent Application Publication
(10) Pub. No.: US 2003/0076305 A1
(43) Pub. Date: Apr. 24, 2003

(54) Keystroke recording device with integral time and date function

(76) Inventor: Stephen D. Allen, Chandler, AZ (US)

Correspondence Address: Stephen D. Allen, 1823 W. Springfield Way, Chandler, AZ, 85248, US

(21) Appl. No.: 10/062,804

(22) Filed: Oct. 22, 2001

(51) Int. Cl. G09G 5/00

(52) U.S. Cl. 345/168

(57) ABSTRACT

A keystroke recording device contains an integral time and date function. The current time and date are associated with recorded activity. It is advantageous for the time and date to be associated with recorded activity so that more information about the recorded events can be presented.

### BACKGROUND OF THE INVENTION

A keystroke recording device is a hardware device which is inserted between a computer and a computer keyboard, which records keystrokes that are typed. A keystroke recording device generally has two connection points, namely one connection point which connects to the computer keyboard interface port, and the other connection point which connects the computer keyboard. The keystroke recording device may be enclosed inside of either the keyboard or the computer. The keystroke recording device has two main components which allow its operation, namely a microcontroller/microprocessor and a storage memory (usually non-volatile memory). The microcontroller/microprocessor has the function of interpreting the communication between the computer and the keyboard. The microcontroller/microprocessor has the additional function of storing keystroke data in the storage memory. The microcontroller/microprocessor also has the function of monitoring the computer/keyboard interface for a command which indicates that administrative functions are desired. Even further, the microcontroller/microprocessor has the function of retrieving data from the storage memory and transmitting the storage memory contents to the computer. The storage memory has the function of storage and retrieval of data which the microcontroller/microprocessor requests.

The stored information can later be retrieved (usually through a key sequence) and sent to the computer through the keyboard interface. The keyboard communicates with the computer over a serial interface with a very limited transmission rate.

While the device is effective for recording and retrieving keystrokes, the times at which activities occur is unknown. In many cases, it is desirable to know the point in time at which recorded activities occurred.

The present invention provides means for embedding a time stamp which allows the time and date of recorded activities to be known. A time-keeping function is embedded within the keystroke recording device which keeps track of time and date functions. The microcontroller/microprocessor has the additional function of recording the time and date in a format such that the time and date are associated with recorded activities.

### DESCRIPTION OF THE PRIOR ART

While the keystroke recording device is known in the prior art, means for associating a time or date with recorded activities are not as yet provided in the prior art.

### BRIEF SUMMARY OF THE INVENTION

In accordance with the invention claimed, means are provided for correcting the problems described earlier wherein the time and date of recorded activities was unknown.

It is, therefore, one object of this invention to provide a capability for the microcontroller/microprocessor inside the keystroke recording device to perform storage of the current time and date in such a way that it is associated with the recorded keystrokes.

Another object of this invention is to provide a capability for an integral time and date function within the keystroke recorder.

Further objects and advantages of the invention will become apparent as the following description proceeds and the features of novelty which characterize the invention will be pointed out with particularity in the claims annexed to and forming a part of this specification.

### DETAILED DESCRIPTION OF THE INVENTION

The prior art contains the same basic functional components, with the exception of a time and date keeping function. The prior art allows the recorded keystrokes to be retrieved in sequential order, but does not allow the time and date of recorded activities to be known.

It is one object of the present invention to have the microcontroller/microprocessor associate the current time and date with the recorded keystrokes.

Another object of this invention is to provide an integral time/date function within the keystroke recording device itself.

Although but a few embodiments of the invention have been described, it will be apparent to those skilled in the art that various changes and modifications may be made herein without departing from the spirit of the invention or from the scope of the appended claims.

What is claimed is:

1. The microcontroller/microprocessor which is an integral part of the keystroke recording device can associate the current time and date with the recorded keystroke activity.

2. A time and date function can be an integral part of the keystroke recording device.
